(19) United States
(12) Patent Application Publication
(10) Pub. No.: US 2013/0078137 A1
(43) Pub. Date: Mar. 28, 2013

(54) USE OF A COPPER ZINC ALLOY

(71) Applicant: Norbert Gaag, Lauf (DE)

(72) Inventor: Norbert Gaag, Lauf (DE)

(21) Appl. No.: 13/685,176

(22) Filed: Nov. 26, 2012

Related U.S. Application Data
(63) Continuation of application No. 11/857,662, filed on Sep. 19, 2007, now abandoned.
Application No. 11/857,662 is a continuation of application No. PCT/EP2006/002945, filed on Mar. 31, 2005.

(30) Foreign Application Priority Data
Apr. 4, 2005 (DE) BRD102005015467.0

(51) Int. Cl. F16C 33/06; C22C 9/10; C22C 9/00; C22C 9/01

(52) U.S. Cl. CPC F16C 33/06; C22C 9/01; C22C 9/10; C22C 9/00
USPC 420/471; 420/486; 420/489

(57) ABSTRACT

A copper zinc alloy that is used as a material for a sliding bearing wherein the alloy comprises 59-73% copper, 2.7-8.5% manganese, 1.5-6.3% aluminum, 0.2-4% silicon, 0.2-3% iron, 0-2% lead, 0-2% nickel, 0-0.4% tin, residual zinc and unavoidable impurities.

### CROSS-REFERENCE TO RELATED APPLICATION

This application is a continuation application of PCT/EP2006/002945; filed Mar. 31, 2005.

### BACKGROUND OF THE INVENTION

1. Field of the Invention

The invention relates to a copper zinc alloy, which is employable for sliding bearings.

2. Discussion of the Prior Art

Among the requirements for a material that is intended to be used as a sliding bearing, the material must possess a low friction coefficient in order to avoid “jamming” and a high wear resistance in order to obtain a long service life. For a sliding bearing in an internal combustion engine, there are currently used copper zinc alloys of the type CuZn31Si1. However, the properties of the CuZn31Si1 alloys no longer meet the requirements that are imposed on materials for sliding bearings in modern engines, for instance, diesel engines. In such diesel engines, the operating temperature of the sliding bearings may reach and exceed 300° C. The employed copper zinc alloys; however, soften at temperatures around 250° C. Consequently, sliding bearings made of this alloy no longer have the requisite strength at the operating temperature.

In recognition of these circumstances, the invention is therefore based on the problem of providing a copper zinc alloy for use as a material for sliding bearings, wherein the copper zinc alloy meets the requirements imposed on a material for sliding bearings, in particular at elevated temperatures, and can also be easily produced.

### SUMMARY OF THE INVENTION

The object is achieved according to the invention by the use of a copper zinc alloy as a material for sliding bearings wherein the alloy comprises 59-73% copper, 2.7-8.5% manganese, 1.5-6.3% aluminum, 0.2-4% silicon, 0.2-3% iron, 0-2% lead, 0-2% nickel, 0-0.4% tin, residual zinc and unavoidable impurities.

The figures given in percent relate here and hereafter to percent by weight.

Consequently, a novel use for a copper zinc alloy is therefore specified. A similar alloy according to DE 29 19 478 C2 is used as a synchronizing ring alloy and is known to those skilled in the art because of this field of use as an alloy, which has a high friction coefficient in combination with the other intrinsic material properties. However, a high friction coefficient is disadvantageous for the use of a material as a sliding bearing, since a high friction coefficient describes a strong interaction between the sliding bearing and its surroundings and is also expressed by a great tendency to jam during the sliding operation. Therefore, the material claimed for the novel use as a sliding bearing has not previously been considered as a sliding bearing material. In relation to the friction coefficient of the previously used CuZn31Si1 alloys, however, the friction coefficient of the claimed copper zinc alloy is lower than that of known sliding bearing materials. This is completely surprising and contrary to the “high” friction coefficient familiar to a person skilled in the art and well established for a synchronizing ring alloy.

Apart from the low friction coefficient and a good wear resistance, it has been found that the claimed copper zinc alloy has a surprisingly good thermal stability. This unexpected combination of material properties makes use as a material for sliding bearings possible for the first time.

The requirement that it can be produced well and easily is satisfied by it being possible for the material for sliding bearings to be produced in bar form by semicontinuous or fully continuous casting, extruding and drawing, that is to say by hot and cold forming.

### DETAILED DESCRIPTION OF THE INVENTION

The alloy has a microstructure which comprises an alpha mixed crystal component and a beta mixed crystal component.

In an advantageous development, the copper zinc alloy for use as a material for sliding bearings comprises 68-72.5% copper, 5.8-8.5% manganese, 3.6-6.3% aluminum, 0.5-3.3% silicon, 0.2-2.5% iron, 0.2-1.9% lead, 0-1.5% nickel, 0-0.4% tin, residual zinc and unavoidable impurities.

The microstructure of the developed alloy produced according to DE 29 19 478 C2 comprises an alpha and beta mixed crystal matrix with up to 60-85% alpha phase. The microstructure also includes hard intermetallic compounds, for example iron-manganese silicides. The alpha phase is decisive for the thermal stability of the alloy.

Sliding bearings of this alloy have a particularly high wear resistance, which is even much higher than that of the alloy CuZn31Si1. The low dry frictional wear in the case of sliding bearings of said alloy results in better behavior under inadequate lubricating conditions. Consequently, the high wear resistance also ensures the emergency running properties of a sliding bearing. The wear-reducing effect is particularly advantageous especially at temperatures around 300° C., the operating temperature of the sliding bearings in modern engines.

In comparison with the previously used CuZn31Si1 alloys, the novel claimed sliding bearing material has a lower jamming tendency, which is attributable to the significantly reduced friction coefficient.

In a preferred alternative, the use is claimed of a copper zinc alloy wherein the alloy comprises 68.9-71.4% copper, 6.9-8.5% manganese, 4.3-6% aluminum, 1.1-2.6% silicon, 0.4-1.9% iron, 0.3-1.6% lead, 0-0.8% nickel, 0-0.4% tin, residual zinc and unavoidable impurities.

The microstructure of the alloy produced in the customary way has an alpha and beta crystal matrix with up to 80% distributed alpha phase. Hard intermetallic compounds, for example iron-manganese silicides, are additionally contained.

It is advantageous for the use of this alloy as a material for sliding bearings that there is a stable high hardness level in the desired operating range above 300° C., and the softening of the alloy only begins well over 100 K above the softening temperature of currently used CuZn31Si1 alloys.

Advantageously used as a material for sliding bearings is a copper zinc alloy wherein the alloy comprises 69.5-70.5% copper, 7.4-8.1% manganese, 4.8-5.7% aluminum, 1.5-2.2% silicon, 0.8-1.4% iron, 0.4-1.2% lead, 0-0.3% nickel, 0-0.4% tin, residual zinc and unavoidable impurities.

The microstructure of said, correspondingly produced alloy has a matrix of beta mixed crystals in which alpha deposits are embedded. Also contained in the microstructure are likewise randomly dispersed manganese-iron silicides. Apart from a low friction coefficient and a high wear resistance, this alloy has a high softening temperature.

In a preferred alternative, used as a material for sliding bearings is a copper zinc alloy wherein the alloy comprises 69.4-71.4% copper, 7.4-8.1% manganese, 4.8-5.7% aluminum, 1.7-2.2% silicon, 0.8-1.4% iron, 0.4-1.2% lead, 0-0.3% nickel, 0-0.4% tin, residual zinc and unavoidable impurities.

Sliding bearings of this alloy have a particularly high wear resistance. The low dry frictional wear in the case of sliding bearings of said alloy results in better behavior under inadequate lubricating conditions. Consequently, the high wear resistance also ensures the emergency running properties of a sliding bearing. The wear-reducing effect is particularly advantageous especially at temperatures around 300° C., the operating temperature of the sliding bearings in modern engines.

Intermetallic compounds, in particular iron-manganese silicides, determine the high wear resistance the wear resistance increasing with an increasing proportion of intermetallic compounds in the alloy. A high proportion of intermetallic compounds are brought about by a high proportion of Si, a high proportion of the α phase, for the thermal stability of the alloy, being ensured by the high Cu content with the iron and manganese contents remaining the same.

In a further embodiment, used as a material for sliding bearings is a copper zinc alloy wherein the alloy comprises more than 70 and up to 71.4% copper, 7.4-8.1% manganese, 4.8-5.7% aluminum, 1.8-2.2% silicon, 0.8-1.4% iron, 0.4-1.2% lead, 0-0.3% nickel, 0-0.4% tin, residual zinc and unavoidable impurities.

Sliding bearings of this alloy have a particularly high wear resistance. The low dry frictional wear in the case of sliding bearings of said alloy results in better behavior under inadequate lubricating conditions. Consequently, the high wear resistance also ensures the emergency running properties of a sliding bearing. The wear-reducing effect is particularly advantageous especially at temperatures around 300° C., the operating temperature of the sliding bearings in modern engines.

Intermetallic compounds, in particular iron-manganese silicides, determine the high wear resistance the wear resistance increasing with an increasing proportion of intermetallic compounds in the alloy. A high proportion of intermetallic compounds are brought about by a high proportion of Si, a high proportion of the α phase, for the thermal stability of the alloy, being ensured by the high Cu content with the iron and manganese contents remaining the same.

In a preferred alternative, used as a material for sliding bearings is a copper zinc alloy wherein the alloy comprises 63.5-67.5% copper, 6-8.5% manganese, 3.6-6.3% aluminum, 0.5-3% silicon, 0.2-2.5% iron, 0.02-1.8% lead, 0-1.5% nickel, 0-0.4% tin, residual zinc and unavoidable impurities.

The microstructure of the developed alloy produced according to DE 29 19 478 C2 comprises an alpha and beta mixed crystal matrix with up to 60-85% alpha phase. The microstructure also includes hard intermetallic compounds, for example iron-manganese silicides. The alpha phase is decisive for the thermal stability of the alloy.

Suitability for use as a material for sliding bearings in modern engines requires the combination of high thermal stability above 300° C. with good wear resistance, which is necessary because of the sliding of a component produced from such materials. In addition, a low friction coefficient is required, by which the slidability of a component produced from such material is improved.

The use of said alloy for sliding bearings is particularly advantageous, since it has a much improved wear behavior in comparison with the previously used copper zinc alloys, and consequently also ensures the emergency running properties of a sliding bearing.

In a further refinement, the use is claimed of a copper zinc alloy wherein the alloy comprises 64.5-66.5% copper, 6.9-8.5% manganese, 4.3-6% aluminum, 0.9-2.6% silicon, 0.4-1.9% iron, 0.1-1.3% lead, 0-0.8% nickel, 0-0.4% tin, residual zinc and unavoidable impurities.

The microstructure of the alloy produced in the customary way has an alpha and beta crystal matrix with up to 80% distributed alpha phase. Hard intermetallic compounds, for example iron-manganese silicides, are additionally contained.

It is advantageous for the use of this alloy as a material for sliding bearings that there is a stable high hardness level in the desired operating range above 300° C., and the softening of the alloy only begins well over 100 K above the softening temperature of currently used CuZn31Si1 alloys.

In a further embodiment, used as a material for sliding bearings is a copper zinc alloy wherein the alloy comprises 65.1-66% copper, 7.4-8.1% manganese, 4.8-5.7% aluminum, 1.3-2% silicon, 0.8-1.4% iron, 0.2-0.9% lead, 0-0.3% nickel, 0-0.4% tin, residual zinc and unavoidable impurities.

The microstructure of said, correspondingly produced alloy has a matrix of beta mixed crystals with alpha deposits. Randomly dispersed iron-manganese silicides are contained in the microstructure.

Apart from a low friction coefficient and a high wear resistance, this alloy also has a high softening temperature.

In a preferred alternative, used as a material for sliding bearings is a copper zinc alloy wherein the alloy comprises 65.1-66% copper, 7.4-8.1% manganese, 4.8-5.7% aluminum, 1.7-2% silicon, 0.8-1.4% iron, 0.2-0.9% lead, 0-0.3% nickel, 0-0.4% tin, residual zinc and unavoidable impurities.

The use of said alloy for sliding bearings is particularly advantageous, since it has a much improved wear behavior in comparison with the previously used copper zinc alloys, and consequently also ensures the emergency running properties of a sliding bearing.

Intermetallic compounds, in particular iron-manganese silicides, determine the high wear resistance. The wear resistance increases with an increasing proportion of intermetallic compounds in the alloy. A high proportion of intermetallic compounds are brought about by a high proportion of Si.

In a further embodiment, used as a material for sliding bearings is a copper zinc alloy wherein the alloy comprises 65.1-66% copper, 7.4-8.1% manganese, 4.8-5.7% aluminum, 1.8-2% silicon, 0.8-1.4% iron, 0.2-0.9% lead, 0-0.3% nickel, 0-0.4% tin, residual zinc and unavoidable impurities.

The use of said alloy for sliding bearings is particularly advantageous, since it has a much improved wear behavior in comparison with the previously used copper zinc alloys, and consequently also ensures the emergency running properties of a sliding bearing.

The high wear resistance is determined by intermetallic compounds, in particular iron-manganese silicides. The wear resistance increases with an increasing proportion of intermetallic compounds in the alloy. A high proportion of intermetallic compounds are brought about by a high proportion of Si.

In a preferred alternative, used as a material for sliding bearings is a copper zinc alloy wherein the alloy comprises 68.3-72.7% copper, 5.7-8.5% manganese, 3.6-6.3% aluminum, 0.5-3.3% silicon, 0.2-2.5% iron, 0-0.1% lead, 0-1.5% nickel, 0-0.4% tin, residual zinc and unavoidable impurities.

This alloy has the particular property that, because of the low lead content, it counts as a lead-free alloy and therefore represents a material for sliding bearings that also satisfies the environmental aspect gaining increasing importance in engine construction. In addition, the combination of the properties of this alloy that is important for sliding bearings exceeds the properties of known sliding bearing materials.

The microstructure of the developed alloy produced according to DE 29 19 478 C2 comprises an alpha and beta mixed crystal matrix with up to 60-85% alpha phase. The microstructure also includes hard intermetallic compounds, for example iron-manganese silicides. The alpha phase is decisive for the thermal stability of the alloy.

Sliding bearings of this alloy have a particularly high wear resistance, which is even much higher than that of the alloy CuZn31Si1. The low dry frictional wear in the case of sliding bearings of said alloy results in better behavior under inadequate lubricating conditions. Consequently, the high wear resistance also ensures the emergency running properties of a sliding bearing. The wear-reducing effect is particularly advantageous especially at temperatures around 300° C., the operating temperature of the sliding bearings in modern engines.

In comparison with the previously used CuZn31Si1 alloys, the novel claimed sliding bearing material has a lower jamming tendency, which is attributable to the significantly reduced friction coefficient.

In a further refinement, the use is claimed of a copper zinc alloy wherein the alloy comprises 69.4-71.6% copper, 6.9-8.5% manganese, 4.3-6% aluminum, 1.1-2.6% silicon, 0.4-1.9% iron, 0-0.1% lead, 0-0.8% nickel, 0-0.4% tin, residual zinc and unavoidable impurities.

The microstructure of the alloy produced in the customary way has an alpha and beta crystal matrix with up to 80% alpha phase. Hard intermetallic compounds, for example iron-manganese silicides, are additionally contained.

Advantageous for the use of this lead-free and consequently environmentally compatible alloy as a material for sliding bearings is that there is a high hardness level in the desired operating range above 300° C., and the softening of the alloy only begins above the softening temperature of currently used CuZn31Si1 alloys.

In a further embodiment, used as a material for sliding bearings is a copper zinc alloy wherein the alloy comprises 70-71% copper, 7.4-8.1% manganese, 4.8-5.7% aluminum, 1.5-2.2% silicon, 0.8-1.4% iron, 0-0.1% lead, 0-0.3% nickel, 0-0.4% tin, residual zinc and unavoidable impurities.

The microstructure of said, correspondingly produced alloy has an alpha and beta mixed crystal matrix. Likewise randomly dispersed manganese-iron silicides are contained in the microstructure.

Apart from a low friction coefficient and an improved wear resistance, this lead-free, environmentally compatible alloy also has a higher softening temperature.

In a preferred alternative, used as a material for sliding bearings is a copper zinc alloy wherein the alloy comprises 69.4-71.4% copper, 7.4-8.1% manganese, 4.8-5.7% aluminum, 1.7-2.2% silicon, 0.8-1.4% iron, 0-0.1% lead, 0-0.3% nickel, 0-0.4% tin, residual zinc and unavoidable impurities.

Sliding bearings of this alloy have a particularly high wear resistance. The low dry frictional wear in the case of sliding bearings of said alloy results in better behavior under inadequate lubricating conditions. Consequently, the high wear resistance also ensures the emergency running properties of a sliding bearing. The wear-reducing effect is particularly advantageous especially at temperatures around 300° C., the operating temperature of the sliding bearings in modern engines.

The high wear resistance is determined by intermetallic compounds, in particular iron-manganese silicides, the wear resistance increasing with an increasing proportion of intermetallic compounds in the alloy. A high proportion of intermetallic compounds is brought about by a high proportion of Si, a high proportion of the □ phase, for the thermal stability, being ensured by the high Cu content.

In a further embodiment, used as a material for sliding bearings is a copper zinc alloy wherein the alloy comprises more than 70 and up to 71.4% copper, 7.4-8.1% manganese, 4.8-5.7% aluminum, 1.8-2.2% silicon, 0.8-1.4% iron, 0-0.1% lead, 0-0.3% nickel, 0-0.4% tin, residual zinc and unavoidable impurities.

Sliding bearings of this alloy have a particularly high wear resistance. The low dry frictional wear in the case of sliding bearings of said alloy results in better behavior under inadequate lubricating conditions. Consequently, the high wear resistance also ensures the emergency running properties of a sliding bearing. The wear-reducing effect is particularly advantageous especially at temperatures around 300° C., the operating temperature of the sliding bearings in modern engines.

The high wear resistance is determined by intermetallic compounds, in particular iron-manganese silicides, the wear resistance increasing with an increasing proportion of intermetallic compounds in the alloy. A high proportion of intermetallic compounds are brought about by a high proportion of Si, a high proportion of the □ phase, for the thermal stability of the alloy, being ensured by the high Cu content with the iron and manganese contents remaining the same.

Used in an expedient way, as a material for sliding bearings is a copper zinc alloy wherein the alloy additionally comprises at least one of the elements chromium, vanadium, titanium or zirconium with up to 0.1%.

The addition of these elements to the copper zinc alloy has the effect of making the grains finer.

In addition, when used for a sliding bearing, the copper zinc alloy may comprise at least one of the following elements with a concentration ≦0.0005% boron, ≦0.03% antimony, ≦0.03% phosphorus, <0.03% cadmium, ≦0.05% chromium, ≦0.05% titanium, ≦0.05% zirconium and ≦0.05% cobalt.

A number of exemplary embodiments are explained in more detail on the basis of the following description and on the basis of Table 1.

Currently used as a material for sliding bearings that are subjected to moderate thermal stress are copper zinc alloys of the CuZn31Si1 type with approximately the following composition: 68% copper, 1% silicon, 0.3% lead and residual zinc. This alloy is referred to hereafter as the standard alloy. Alloy 1 corresponds to the alloy from claim 4 and has a composition of 70% copper, 7.7% manganese, 5.2% aluminum, 1.8% silicon, 1.1% iron, 0.8% lead, residual zinc and unavoidable impurities. Alloy 2 corresponds to the alloy from claim 9 and has a composition of 65.5% copper, 7.7% manganese, 5.2% aluminum, 1.6% silicon, 1% iron, 0.5% lead, 0.1% nickel, 0.2% tin, residual zinc along with unavoidable impurities. Alloy 3 corresponds to the alloy from claim 14 and has a composition with 70.5% copper, 7.7% manganese, 5.2% aluminum, 1.8% silicon, 1.1% iron, 0.05% lead, 0.1% nickel, 0.2% tin, residual zinc and unavoidable impurities.

The softening behavior of the various materials has been investigated up to a temperature of 600° C. This showed that the hardness of the standard alloy for sliding bearings falls significantly from a temperature as low as 250° C. and, at 400° C., is only 130 HV50, the fall in the hardness progressing continuously with increasing temperature. By contrast with this, no reduction in hardness was measured for alloy 1 in the temperature range between 200 and 450° C. Only after 450° C. does the hardness of alloy 1 also fall as the temperature increases further. Alloy 3 likewise shows a constant hardness value from 250 to 430° C. The stable hardness value of alloy 3 therefore extends beyond the range in which the standard alloy already displays significant losses in hardness. The progression of the hardness values of alloy 2 is comparable to the hardness progression of the standard alloy, but alloy 2 has a much higher hardness.

Consequently, alloys 1 and 3, and to some extent alloy 2, have their maximum hardness at the temperatures that correspond to the operating temperature of sliding bearings in modern engines.

The electrical conductivity can be used as a measure of the thermal conductivity, a high value standing for good thermal conductivity. The standard alloy has an electrical conductivity of 8.2 m/Ωmm². The electrical conductivity of alloys 1, 2 and 3 is lower than that of the standard alloy at 4.6 m/Ωmm², 4 m/Ωmm² and 5.4 m/Ωmm², respectively. This means that the heat dissipation of alloys 1, 2 and 3 is reduced in comparison with the standard alloy. However, as a result of the otherwise superior properties, this is acceptable.

The wear behavior was investigated with and without a lubricant. With lubricant, alloy 3 has the highest wear resistance (1250 km/g). Alloy 1 has a likewise outstanding wear resistance of 961 km/g, which are virtually two orders of magnitude higher than the wear resistance of the standard alloy at 12 km/g. At 568 km/g, the wear resistance of alloy 2 exceeds the wear resistance of the standard alloy by approximately one and a half orders of magnitude.

In investigations of the wear behavior without lubricant, it has been found by way of confirmation that alloys 1 and 3 have distinct advantages over the standard alloy. The wear of the standard alloy is 357 km/g, whereas the wear of the two alloys 1 and 3 is in each case 1250 km/g. The wear resistance is consequently in each case higher by a factor of three than the wear resistance of the standard alloy. In other words, the wear is much less. Alloy 2 has slightly greater wear that the standard alloy of 417 km/g.

Alloys 1, 2 and 3 can be produced with preference by semicontinuous or fully continuous casting, extruding, drawing and straightening.

A friction coefficient of 0.29, such as that of the standard alloy, has until now been considered to be a low friction coefficient, and consequently the material of the type CuZn31Si1 has been considered to be an ideal sliding bearing material. Alloys 1, 2 and 3, which have until now been used as synchronizing ring material—requiring a high friction coefficient—show that, surprisingly, the friction coefficient classified as high for this known use is actually low. For instance, at 0.14, the friction coefficient of alloy 2 is only half the friction coefficient of the standard alloy, classified until now as low. Alloys 1 and 3 even exhibit friction coefficients of 0.10 and 0.11, respectively, which are only one third of the low friction coefficient of the standard alloy. Consequently, alloys 1, 2 and 3 are surprisingly suitable for use as a sliding bearing material that has much improved sliding properties on account of the low friction value.

Alloys 1, 2 and 3 have distinct advantages over the standard alloy used until now for sliding bearings. These advantages concern, inter alia, the softening temperature, the sliding properties and the wear resistance. In addition, the conductivity is also adequate. Consequently, alloys 1, 2 and 3 represent a considerable improvement with respect to use as a sliding bearing material. These alloys meet the requirements imposed on the material because of the increased operating temperatures in modern diesel engines.

Table 1 shows the material properties of a standard copper zinc alloy and of alloy 1, alloy 2 and alloy 3 in comparison.

| | Standard | | | |
|---|---|---|---|---|
| Property | alloy | Alloy 1 | Alloy 2 | Alloy 3 |
| Electrical | 8.2 | 4.6 | 4.0 | 5.4 |
| conductivity | | | | |
| (m/Ωmm²) | | | | |
| Wear, dry (km/g) | 357 | 1250 | 417 | 1250 |
| Wear, lubricated | 12 | 961 | 568 | 1250 |
| (km/g) | | | | |
| Softening | 350 | 480 | 370 | 480 |
| temperature | | | | |
| 10% cold-worked | | | | |
| (° C.) | | | | |
| Friction value | 0.29 | 0.10 | 0.14 | 0.11 |

Having properties comparable to those of alloy 1 is the following alloy: 70.2% copper, 7.8% manganese, 5.3% aluminum, 1.8% silicon, 1.1% iron, 0.8% lead, residual zinc and unavoidable impurities. Having properties similar to those of alloy 2 is an alloy with 65.6% copper, 7.8% manganese, 5.3% aluminum, 1.8% silicon, 1.1% iron, 0.5% lead, 0.1% nickel, 0.2% tin, residual zinc and unavoidable impurities. An alloy with 70.5% copper, 7.8% manganese, 5.3% aluminum, 1.8% silicon, 1.1% iron, 0.05% lead, 0.1% nickel, 0.2% tin, residual zinc and unavoidable impurities shows properties that correspond to those of alloy 3.

1-17. (canceled)

18. A slide bearing consisting essentially of, in percent by weight:
59-73% copper,
2.7-8.5% manganese,
1.5-6.3% aluminum,
0.2-4% silicon,
0.2-3% iron,
0-2% lead,
0-2% nickel,
0-0.4% tin,
residual zinc,
at least one of P and Cr, wherein said P is present in an amount of less than or equal to 0.03% and said Cr is present in an amount of less than or equal to 0.05%, and
unavoidable impurities,
wherein said slide bearing has a microstructure comprising an alpha and beta mixed crystal matrix that comprises 60-85% alpha phase.

19. A method of forming a slide bearing, the method comprising:
providing, in percent by weight:
59-73% copper,
2.7-8.5% manganese,
1.5-6.3% aluminum,
0.2-4% silicon,
0.2-3% iron,
0-2% lead,
0-2% nickel,
0-0.4% tin,
residual zinc,
at least one of P and Cr, wherein said P is present in an amount of less than or equal to 0.03% and said Cr is present in an amount of less than or equal to 0.05%, and
unavoidable impurities,
processing said slide bearing to provide a microstructure comprising an alpha and beta mixed crystal matrix that comprises 60-85% alpha phase.

20. The method as claimed in claim 19, wherein the step of providing comprises providing, in percent by weight, 68-72.5% copper, 5.8-8.5% manganese, 3.6-6.3% aluminum, 0.5-3.3% silicon, 0.2-2.5% iron, 0.2-1.9% lead, 0-1.5% nickel, 0-0.4% tin, residual zinc and unavoidable impurities.

21. The method as claimed in claim 20, wherein the step of providing comprises providing, in percent by weight, 68.9-71.4% copper, 6.9-8.5% manganese, 4.3-6% aluminum, 1.1-2.6% silicon, 0.4-1.9% iron, 0.3-1.6% lead, 0-0.8% nickel, 0-0.4% tin, residual zinc and unavoidable impurities.

22. The method as claimed in claim 21, wherein the step of providing comprises providing, in percent by weight, 69.5-70.5% copper, 7.4-8.1% manganese, 4.8-5.7% aluminum, 1.5-2.2% silicon, 0.8-1.4% iron, 0.4-1.2% lead, 0-0.3% nickel, 0-0.4% tin, residual zinc and unavoidable impurities.

23. The method as claimed in claim 21, wherein the step of providing comprises providing, in percent by weight, 69.4-71.4% copper, 7.4-8.1% manganese, 4.8-5.7% aluminum, 1.7-2.2% silicon, 0.8-1.4% iron, 0.4-1.2% lead, 0-0.3% nickel, 0-0.4% tin, residual zinc and unavoidable impurities.

24. The method as claimed in claim 23, wherein the step of providing comprises providing, in percent by weight, more than 70 and up to 71.4% copper, 7.4-8.1% manganese, 4.8-5.7% aluminum, 1.8-2.2% silicon, 0.8-1.4% iron, 0.4-1.2% lead, 0-0.3% nickel, 0-0.4% tin, residual zinc and unavoidable impurities.

25. The method as claimed in claim 19, wherein the step of providing comprises providing, in percent by weight, 63.5-67.5% copper, 6-8.5% manganese, 3.6-6.3% aluminum, 0.5-3% silicon, 0.2-2.5% iron, 0.02-1.8% lead, 0-1.5% nickel, 0-0.4% tin, residual zinc and unavoidable impurities.

26. The method as claimed in claim 25, wherein the step of providing comprises providing, in percent by weight, 64.5-66.5% copper, 6.9-8.5% manganese, 4.3-6% aluminum, 0.9-2.6% silicon, 0.4-1.9% iron, 0.1-1.3% lead, 0-0.8% nickel, 0-0.4% tin, residual zinc and unavoidable impurities.

27. The method as claimed in claim 26, wherein the step of providing comprises providing, in percent by weight, 65.1-66% copper, 7.4-8.1% manganese, 4.8-5.7% aluminum, 1.3-2% silicon, 0.8-1.4% iron, 0.2-0.9% lead, 0-0.3% nickel, 0-0.4% tin, residual zinc and unavoidable impurities.

28. The method as claimed in claim 27, wherein the step of providing comprises providing, in percent by weight, 65.1-66% copper, 7.4-8.1% manganese, 4.8-5.7% aluminum, 1.7-2% silicon, 0.8-1.4% iron, 0.2-0.9% lead, 0-0.3% nickel, 0-0.4% tin, residual zinc and unavoidable impurities.

29. The method as claimed in claim 28, wherein the step of providing comprises providing, in percent by weight, 65.1-66% copper, 7.4-8.1% manganese, 4.8-5.7% aluminum, 1.8-2% silicon, 0.8-1.4% iron, 0.2-0.9% lead, 0-0.3% nickel, 0-0.4% tin, residual zinc and unavoidable impurities.

30. The method as claimed in claim 19, wherein the step of providing comprises providing, in percent by weight, 68.3-72.7% copper, 5.7-8.5% manganese, 3.6-6.3% aluminum, 0.5-3.3% silicon, 0.2-2.5% iron, 0-0.1% lead, 0-1.5% nickel, 0-0.4% tin, residual zinc and unavoidable impurities.

31. The method as claimed in claim 30, wherein the step of providing comprises providing, in percent by weight, 69.4-71.6% copper, 6.9-8.5% manganese, 4.3-6% aluminum, 1.1-2.6% silicon, 0.4-1.9% iron, 0-0.1% lead, 0-0.8% nickel, 0-0.4% tin, residual zinc and unavoidable impurities.

32. The method as claimed in claim 31, wherein the step of providing comprises providing, in percent by weight, 70-71% copper, 7.4-8.1% manganese, 4.8-5.7% aluminum, 1.5-2.2% silicon, 0.8-1.4% iron, 0-0.1% lead, 0-0.3% nickel, 0-0.4% tin, residual zinc and unavoidable impurities.

33. The method as claimed in claim 31, wherein the step of providing comprises providing, in percent by weight, 69.4-71.4% copper, 7.4-8.1% manganese, 4.8-5.7% aluminum, 1.7-2.2% silicon, 0.8-1.4% iron, 0-0.1% lead, 0-0.3% nickel, 0-0.4% tin, residual zinc and unavoidable impurities.

34. The method as claimed in claim 33, wherein the step of providing comprises providing, in percent by weight, more than 70 and up to 71.4% copper, 7.4-8.1% manganese, 4.8-5.7% aluminum, 1.8-2.2% silicon, 0.8-1.4% iron, 0-0.1% lead, 0-0.3% nickel, 0-0.4% tin, residual zinc and unavoidable impurities.

35. The method as claimed in claim 19, wherein the step of providing comprises providing, in percent by weight, up to 0.1% of a material selected from the group consisting of at least one of the elements: vanadium, titanium or zirconium.
